(19) United States
(12) Patent Application Publication
(10) Pub. No.: US 2011/0265438 A1
(43) Pub. Date: Nov. 3, 2011

(54) TURBINE ENGINE WITH ENHANCED FLUID FLOW STRAINER SYSTEM

(76) Inventor: William R. Ryan, Oviedo, FL (US)

(21) Appl. No.: 12/769,977

(22) Filed: Apr. 29, 2010

(51) Int. Cl. B01D 35/28

(52) U.S. Cl. 55/503

(57) ABSTRACT

A fuel delivery system for a turbine engine includes a fluid supply conduit. The conduit has an inner peripheral surface that defines a flow supply passage. A fuel strainer is received in the conduit. The strainer has a hollow, generally frusto-conical body with an outer peripheral surface. The strainer has a longitudinal axis. A plurality of holes extends through the body substantially radially to the longitudinal axis. The holes have an associated effective flow area. The outer peripheral surface of the body is radially spaced from the inner peripheral surface of the conduit along the length of the strainer such that a flow area is defined between the outer peripheral surface of the strainer body and the inner peripheral surface of the fluid supply conduit. The flow area is equal to or greater than the effective flow area of the strainer holes along the length of the strainer.

### FIELD OF THE INVENTION

The invention relates in general to turbine engines and, more particularly, to fuel delivery systems in a turbine engine.

### BACKGROUND OF THE INVENTION

A typical turbine engine has a compressor section, a combustor section and a turbine section. During engine operation, air can be inducted into the compressor section and compressed. The compressed air can enter the combustor section where it can be mixed with fuel. The air-fuel mixture is ignited to form a high temperature working gas, which is routed to the turbine section.

Fuel can be delivered at various points in the combustor section by way of fuel supply passages. A strainer can be positioned within such fuel supply passages. The strainer can be used to remove particles that could potentially clog the fuel injection outlet holes. Such undesired particles may enter the fuel supply passages due to impurities or contaminants in the fuel itself and/or due to debris entering the fuel passage after manufacturing of the combustor.

FIG. 1 shows an example of a known fuel strainer 10. The strainer 10 has a hollow, generally frusto-conical body 12. The strainer 10 has an outer peripheral surface 14. A plurality of relatively small holes 16 is provided in the body 12. These holes 16 serve to remove undesired particles from fuel flowing through the strainer 10. The fuel strainer 10 has an open upstream end 18 and a downstream end 20 relative to the direction of fuel flow through the strainer 10. The strainer 10 can have a flange 22 to facilitate mounting within a fuel line.

FIG. 2 shows an example of a fuel delivery system 24 in a turbine engine. The system 24 includes a fuel supply pipe 26. The fuel supply pipe 26 has an inner peripheral surface 28 defining a flow passage 30. The flow passage 30 has a constant size, shape and cross-sectional area. After flowing into the strainer 10 through the open upstream end 18, fuel 32 is forced generally radially outwardly through the holes 16 in the strainer body 12. Undesired particles are removed from the fuel 32, and the fuel 32 continues to flow along the inner flow passage 30.

The effective flow area of the holes 16 in the strainer 10 is less than the actual geometric area of these holes 16 due to the phenomenon of vena contracta. However, experience has shown that, in the case of the fuel strainer 10, the effective flow area of the holes 16 is reduced beyond the expected effects of vena contracta. Indeed, based on calculations, the size of the strainer holes 16 do not appear to appreciably control the effective flow area of the holes.

This issue has been exacerbated by efforts to achieve the low NOx levels mandated by regulatory agencies and required by customers. Such efforts have lead gas turbine combustion designers to rely on lean-premixed combustor designs to reduce flame temperatures. To achieve such goals, designers have sought to reduce the size of burners, including the size of fuel supply pipes and fuel strainers. Supply pressure calculations with the new strainer designs have revealed that the drop in fuel supply pressure may limit the range of fuel splits that can be implemented at base load, which, of course, may limit the tuning effectiveness of the burners.

Thus, there is a need for a system that can minimize such concerns.

### SUMMARY OF THE INVENTION

Aspects of the invention are directed to a fluid flow straining system for a turbine engine. The system includes a fluid supply conduit connected in fluid communication to supply a fluid to a turbine engine component, which can be, for example, a pilot nozzle system, a main nozzle system and/or a premix nozzle system located upstream of the combustion zone. The fluid supply conduit can be, for example, a part of a fuel supply line for a turbine engine. The fluid supply conduit has an inner peripheral surface that defines a flow supply passage.

The system further includes a strainer that has a hollow generally frusto-conical body with an outer peripheral surface. The strainer includes a longitudinal axis. A plurality of holes extends through the body substantially radially to the longitudinal axis. That is, the holes can extend through the body in any direction that is radial to the longitudinal axis of the strainer, including, for example, in radial directions that are substantially perpendicular to the longitudinal axis. The plurality of holes has an associated effective flow area. The strainer has a downstream end and an open upstream end.

The strainer is received in the fluid supply conduit such that the outer peripheral surface of the body is radially spaced from the inner peripheral surface of the fluid supply conduit along at least a portion of the length of the strainer. As a result, a flow area is defined between the outer peripheral surface of the strainer body and the inner peripheral surface of the fluid supply conduit. The flow area is equal to or greater than the effective flow area of the strainer holes along the at least a portion of the length of the strainer.

The fluid supply conduit can have a first portion transitioning to a second portion. The inner peripheral surface of the first portion can be at a first diameter, and the inner peripheral surface of the second portion can be at a second diameter. The second diameter can be greater than the first diameter. In one embodiment, the second diameter can be at least about 2 millimeters larger than the first diameter. In another embodiment, the second diameter can be from about 2 millimeters to about 6 millimeters larger than the first diameter. In still another embodiment, the second diameter can be at least about 40 percent greater than the first diameter.

The strainer body can be sized to be received within the first portion of the fluid supply conduit. The strainer can be partially located within the first portion of the fluid supply conduit and partially within the second portion of the fluid supply conduit. More particularly, a greater portion of the strainer can be located within the second portion of the fluid supply conduit than the first portion of the fluid supply conduit. Still more particularly, a substantially greater portion of the strainer is located within the second portion of the fluid supply conduit than the first portion of the fluid supply conduit.

The inner peripheral surface of the fluid supply conduit can be tapered. In such case, the radial spacing between the outer peripheral surface of the body and the inner peripheral surface of the fluid supply conduit can be substantially constant along at least a portion of the length of the strainer. In one alternative embodiment, the radial spacing between the outer peripheral surface of the body and the inner peripheral surface of the fluid supply conduit can be greater in an upstream region proximate to the upstream end of the strainer than in a downstream region proximate the downstream end of the strainer.

A second fluid flow straining system for a turbine engine according to aspects of the invention includes a fluid supply conduit. The fluid supply conduit is connected in fluid communication to supply a fluid to a turbine engine component, which can be, for example, a pilot nozzle system, a main nozzle system and/or a premix nozzle system located upstream of a combustion zone. The fluid supply conduit has an inner peripheral surface defining a flow supply passage. The fluid supply conduit has a first portion in which the inner peripheral surface is at a first diameter. The first portion transitions to a second portion in which the diameter of the inner peripheral surface greater than the first diameter along at least a portion of length of the flow supply passage. The transition between the first diameter and the second diameter can be a step. In one embodiment, the second diameter can at least about 2 millimeters larger than the first diameter. In another embodiment, the second diameter can be at least about 40 percent greater than the first diameter.

The system also includes a strainer that has a hollow generally frusto-conical body with an outer peripheral surface. A plurality of holes is provided in the body. The strainer has an open upstream end and a closed downstream end. The strainer body is sized to be received within the first portion of the fluid supply conduit.

The strainer is received within the fluid supply conduit such the strainer body is partially located within the first portion of the flow passage and partially within the second portion of the fluid supply conduit. The outer peripheral surface of the body is radially spaced from the inner peripheral surface of the fluid supply conduit in the second portion of the fluid supply conduit.

The plurality of holes in the strainer can have an associated effective flow area. A flow area can be defined between the outer peripheral surface of the strainer body and the inner peripheral surface of the fluid supply conduit. The flow area can be equal to or greater than the effective flow area of the strainer holes in the second portion along the length of the strainer received in the second portion.

In a third fluid flow straining system for a turbine engine according to aspects of the invention, a fluid supply is conduit connected in fluid communication to supply a fluid to a turbine engine component, such as a pilot nozzle system, a main nozzle system and/or a premix nozzle system located upstream of a combustion zone. The fluid supply conduit has an inner peripheral surface that defines a flow supply passage. At least a portion of the inner peripheral surface is tapered.

The system includes a strainer that has a hollow generally frusto-conical body with an outer peripheral surface. A plurality of holes is provided in the body. The strainer has an open upstream end and a closed downstream end. The strainer body is sized to be received within the first portion of the fluid supply conduit.

The strainer is received within the fluid supply conduit such the strainer body is partially located within the first portion of the flow passage and partially within the second portion of the fluid supply conduit. The outer peripheral surface of the body is radially spaced from the inner peripheral surface of the fluid supply conduit in the second portion of the fluid supply conduit. In one embodiment, the radial spacing between the outer peripheral surface of the body and tapered the inner peripheral surface of the fluid supply conduit can be substantially constant along the at least a portion of the length of the strainer.

The plurality of holes in the strainer can have an associated effective flow area. A flow area can be defined between the outer peripheral surface of the strainer body and the inner peripheral surface of the fluid supply conduit. The flow area is equal to or greater than the effective flow area of the strainer holes in the second portion along the length of the strainer received in the second portion.

### BRIEF DESCRIPTION OF THE DRAWINGS

FIG. 1 is a side elevation cross-sectional view of a known fuel strainer.

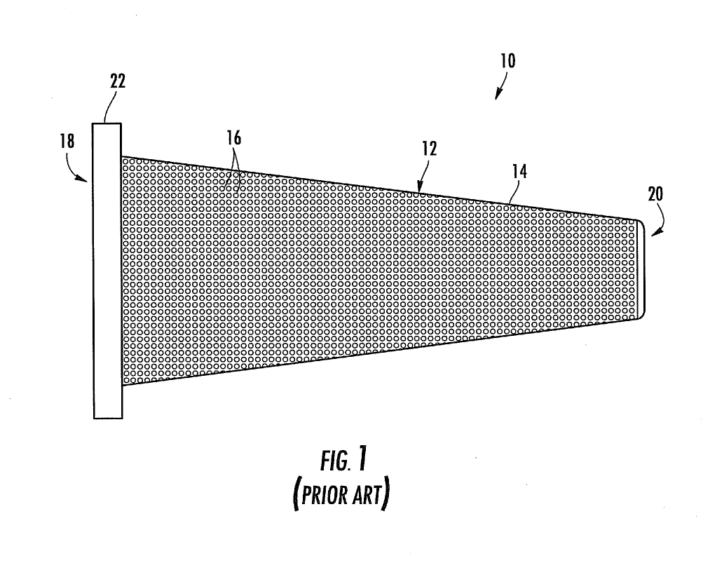

FIG. 2 is a side elevation cross-sectional view of a known fuel delivery system, showing a fuel supply pipe with a fuel strainer disposed therein.

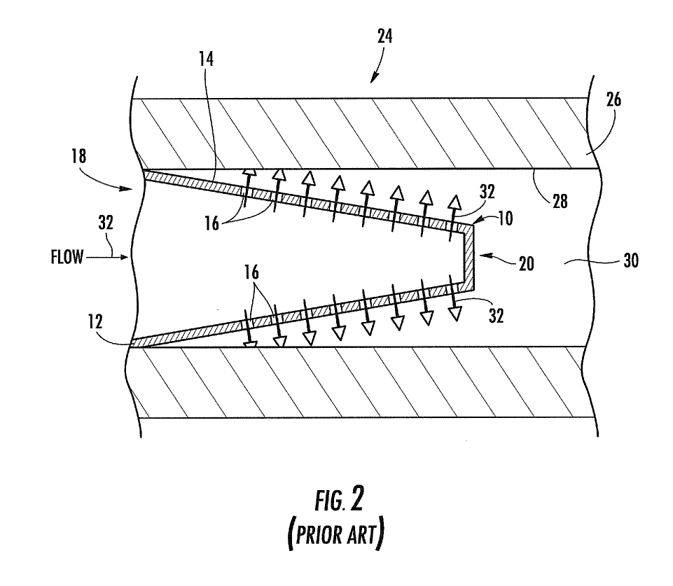

FIG. 3 is a side elevation cross-sectional view of a first embodiment of a fluid supply conduit configured according to aspects of the invention.

FIG. 4 is a side elevation cross-sectional view of a second embodiment of a fluid supply conduit configured according to aspects of the invention.

### DETAILED DESCRIPTION OF EMBODIMENTS OF THE INVENTION

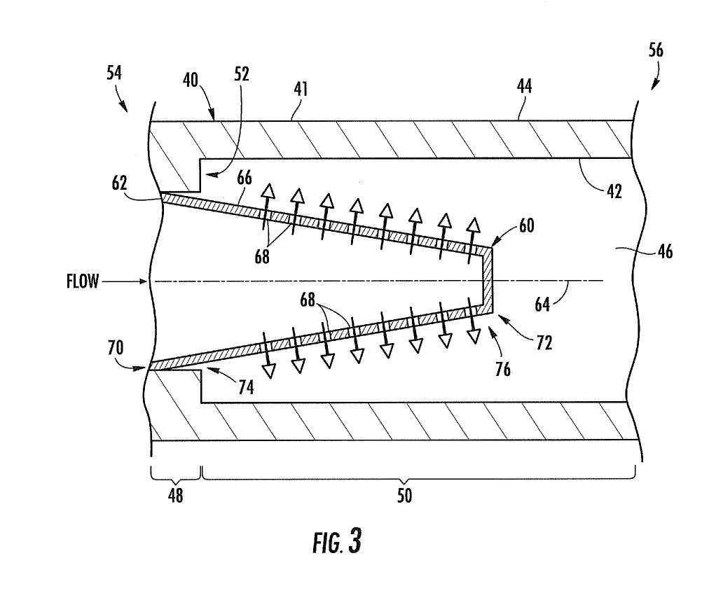

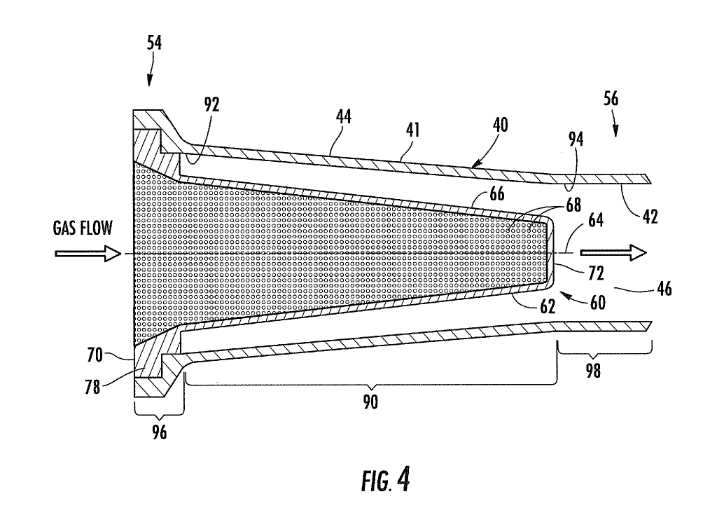

Embodiments of the invention are directed to strainer systems for use in fluid flows. Aspects of the invention will be explained in connection with a fuel delivery system for a turbine engine, but the detailed description is intended only as exemplary. Indeed, it will be appreciated that aspects of the invention can be applied to other areas of a turbine engine in which there is a fluid flow as well as in other applications. Embodiments of the invention are shown in FIGS. 3-4, but the present invention is not limited to the illustrated structure or application.

It is suspected that the outer peripheral surface of the strainer may be too close to the inner peripheral surface of the fuel supply pipe. In such area, the flow area defined between the outer peripheral surface of the strainer and the inner peripheral surface of the fluid supply pipe is less than the effective area of the strainer holes. As a result, there can be restrictions in the flow exiting the fuel strainer, particularly near the upstream end of the fuel strainer where the hole exit flow is the largest and the distance between the outer peripheral surface of the strainer and the inner peripheral surface of the fuel supply pipe is the smallest. Such restrictions in the flow result in a loss in pressure in the fuel flow. According to aspects of the invention, the structure of the can be adapted to ensure that the restrictions in the flow exiting the strainer are avoided.

Referring to FIG. 3, a fluid supply conduit 40 is provided. The fluid supply conduit 40 can be defined by any suitable structure including, for example, by one or more pipes, tubes, and/or fittings, just to name a few possibilities. In one embodiment, the fluid supply conduit 40 can be a fuel pipe 41 in a fuel delivery system of a turbine engine. The fluid supply conduit 40 can include an inner peripheral surface 42 and an outer peripheral surface 44. The inner peripheral surface 42 can define a flow passage 46. The flow passage 46 can be generally circular in cross-sectional shape; however, other cross-sectional shapes may be used.

The fluid supply conduit 40 can have a first portion 48 transitioning to a second portion 50. In the first portion 48, the inner peripheral surface 42 can be at a first diameter. The first diameter can extend along the entire length of the first portion 48. In the second portion 50, the inner peripheral surface 42 can be at a second diameter that is greater than the first diameter. The second diameter can be at least about 2 millimeters larger than the first diameter. The second diameter can be from about 2 millimeters to about 6 millimeters larger than the first diameter. The second diameter can be at least about 40 percent greater than the first diameter.

In one embodiment, the second diameter can extend along the entire length of the second portion 50. In some instances, the remainder of the flow passage 46 can be at the second diameter until the fuel injector outlet (not shown) is reached. In one embodiment, the second diameter of the inner peripheral surface 42 of the fluid supply conduit 40 may end prior to the downstream end of the fluid supply conduit 40. In such case, the diameter of the fluid supply conduit 40 can increase and/or decrease thereafter.

There can be any suitable transition between the first and second portions 48, 50 of the fluid supply conduit 40. In one embodiment, the transition can be in the form of a step 52, as is shown in FIG. 3, or other rapid change between the first and second portions 48, 50. In other embodiments, the transition can be more gradual, such as in the form of a flare or curve.

An upstream portion 54 of the fluid supply conduit 40 can be in fluid communication to receive a fluid from a fluid source (not shown). In one embodiment, the fluid can be fuel. Any suitable type of fluid can be used, and the fluid can be in liquid or gas form. A downstream portion 56 of the fluid supply conduit 40 can be in fluid communication with a fluid injection outlet (not shown), which can be, for example, a hole. In the case where the fluid is fuel, the fluid injection outlet can be any suitable fuel injection outlet in a turbine engine. For example, the fuel injection outlet can be part of a pilot nozzle system, a main nozzle system and/or a premix nozzle system located upstream of the combustion zone.

It should be noted that the fluid supply conduit 40 can be provided as a separate piece that is connected to existing conduits in the fluid delivery system. In such case, the upstream and downstream portions 54, 56 of the fluid supply conduit 40 can be adapted to facilitate such connection. For example, the upstream and downstream portions 54, 56 of the fluid supply conduit 40 can be equipped with suitable fittings, couplings or connectors.

A strainer 60 can be received within the fluid supply conduit 40. The strainer 60 can have a hollow, generally frusto-conical body 62. The body 62 can be non-segmented. The strainer 60 can have an associated longitudinal axis 64. The strainer 60 has an outer peripheral surface 66. A plurality of holes 68 is provided in the body 62. The holes 68 can have any suitable cross-sectional size and shape. In one embodiment, the holes 68 can be circular in cross-sectional shape, but other cross-sectional geometries are possible.

The strainer 60 can have an open upstream end 70 and a closed downstream end 72. The strainer 60 can be generally conical and, more particularly, frusto-conical. The strainer 60 can taper from a major diameter at an upstream end region 74 to a minor diameter at a downstream end region 76. The upstream end 70 and/or downstream end 72 can include one or more structures to facilitate placement, arrangement, positioning, mounting and/or attachment of the strainer 60 in the fluid supply conduit 40. For instance, the upstream end 70 of the strainer 60 can include a flange 78 (see FIG. 4).

The strainer body 62 can be sized to be received within the first portion 48 of the fluid supply conduit 40. The strainer 60 can be positioned in the fluid supply conduit 40 such that a portion of the strainer body 62 including the upstream end 70 is located within the first portion 48 of the flow passage 46. The remainder of the strainer 60 can be located within the second portion 50 of the flow passage 46. In one embodiment, a greater portion of the length of strainer body 62 can be located within the second portion 50 of the flow passage 46 than in the first portion 48 of the flow passage 46. In some instances, a substantially greater portion of the length of the strainer body 62 can be located within the second portion 50 of the flow passage 46 than in the first portion 48 of the flow passage 46. The strainer 60 can be arranged so that the strainer body 62 is positioned to the greatest extent possible within the second portion 50 of the flow passage 46.

The outer peripheral surface 66 of the strainer 60 can be radially spaced from the inner peripheral surface 42 of the flow supply conduit 40. The term “radially” means in any direction radial to the longitudinal axis 64 of the strainer 60, including, for example, in radial directions that are substantially perpendicular to the longitudinal axis 64. This spacing can define a flow area for the fluid exiting the strainer 60. The holes 68 in the strainer body 62 can define an associated flow area. According to aspects of the invention, the flow area defined between the outer peripheral surface 66 of the strainer 60 and the inner peripheral surface 42 of the fluid supply conduit 40 is equal to or greater than the effective flow area of the strainer holes 68 at all points along the length of the strainer 60. Effective flow area at a given point along the length of the strainer 60 means the flow area defined by the strainer holes 68 at that point as well as all strainer holes 68 upstream thereof, after the effects of vena contracta have been taken into account. The effective flow area is less than the actual geometric area of the holes 68.

Thus, it will be appreciated that a fluid supply conduit 40 configured in accordance with aspects of the invention can lead to less flow restriction, and, in turn, less of a pressure drop in the fluid flow. Thus, in the context of a fuel delivery system in a turbine engine, the range of fuel splits that can be implemented at base load can be preserved, allowing for effective tuning of the combustor burners.

According to calculations comparing the predicted effective strainer hole area (assuming a coefficient of contraction of 0.65) and the predicted cross-sectional flow area between the outer peripheral surface of the strainer and the inner peripheral surface of the flow supply conduit along the length of the strainer in the main nozzle for a sample premix burner, an increase of at least about 1 millimeter in the radius of the inner peripheral surface 42 of the fluid supply conduit 40 can result in the predicted cross-sectional flow area between the outer peripheral surface 66 of the strainer 60 and the inner peripheral surface 42 of the fluid supply conduit 40 that is equal to or greater than the predicted effective hole area at any point along almost the entire length, if not the entire length, of the flow strainer 60.

As will be appreciated, the radial spacing between the outer peripheral surface 66 of the strainer 60 and inner peripheral surface 42 of the fluid supply conduit 40 becomes less critical in downstream regions of the flow strainer 60 where the pressure drop begins to be controlled by the area of the strainer holes 68 as opposed to the available flow area between the outer peripheral surface 66 of the strainer 60 and inner peripheral surface 42 of the fluid supply conduit 40. Thus, at least with respect to the configuration shown in FIG. 3, there may be a point of diminishing returns with respect to maintaining the inner peripheral surface 42 of the fluid supply conduit 40 at the relatively large second diameter along the entire length of the strainer 60.

Accordingly, embodiments of a system according to aspects of the invention can include an alternative arrangement, as is shown in FIG. 4. In such case, at least a portion 90 of the inner peripheral surface 42 of the fluid supply conduit 40 can be tapered. For convenience, like features between the embodiments shown in FIGS. 3 and 4 are designated with the same reference numbers. Any suitable cone angle defined between the outer peripheral surface 66 of the strainer 60 and inner peripheral surface 42 of the fluid supply conduit 40 can be used for the taper. In some instances, more than one cone angle may be used in the tapered portion 90.

In the tapered portion 90, the inner peripheral surface 42 can begin at a first diameter at an upstream point 92 thereof (relative to the direction of fluid flow through the strainer 60). The diameter of the inner peripheral surface 42 can decrease therefrom at any suitable cone angle to a second diameter at a downstream point 94 thereof. The cone angle can be adjusted to reduce resistance to the flow out of the strainer. In one embodiment, the cone angle can be substantially the same as the cone angle of the outer peripheral surface 66 of the fuel strainer 60. The cone angle can be selected so that the flow area defined between the outer peripheral surface 66 of the strainer 60 and the inner peripheral surface 42 of the fluid supply conduit 60 is equal to or greater than the effective flow area of the strainer holes 68.

In some instances, the fluid strainer 60 can have an upstream portion 96 and a downstream portion 98. In the upstream portion, the inner peripheral surface 42 can be adapted to facilitate placement, arrangement, positioning, mounting, engagement and/or attachment of the strainer 60 in the fluid supply conduit 40, such as a flange 78 of the strainer 60. In the downstream portion, the inner peripheral surface 42 can have any suitable configuration. In one embodiment, the inner peripheral surface 42 can be at a constant diameter, as is shown in FIG. 4. In such case, the diameter can be substantially the same as the diameter of the fluid conduit upstream of the fuel strainer 60. In some instances, there may not be an upstream portion 96 and/or a downstream portion 98. In such case, the entire inner peripheral surface 42 can be tapered.

The outer peripheral surface 44 of the fluid supply conduit 40 of FIG. 4 can be tapered as well. In such case, it will be appreciated that the fluid supply conduit shown in FIG. 4 may be more compact than the fluid supply conduit shown in FIG. 3. Such compactness may facilitate efforts to rely on lean-premixed combustor designs to reduce flame temperatures and, in turn, to achieve the low NOx levels mandated by regulatory agencies and required by customers.

The foregoing description is provided in the context of one possible application for the system according to aspects of the invention. While the above description is made in the context of a fuel delivery system for a turbine engine, it will be understood that the system according to aspects of the invention can be applied to other fluid delivery systems. Thus, it will of course be understood that the invention is not limited to the specific details described herein, which are given by way of example only, and that various modifications and alterations are possible within the scope of the invention as defined in the following claims.

What is claimed is:

1. A fluid flow straining system for a turbine engine comprising:
a fluid supply conduit connected in fluid communication to supply a fluid to a turbine engine component, the fluid supply conduit having an inner peripheral surface defining a flow supply passage; and
a strainer having a hollow generally frusto-conical body with an outer peripheral surface, the strainer including a longitudinal axis, a plurality of holes extending through the body substantially radially to the longitudinal axis, the plurality of holes having an associated effective flow area, the strainer having a downstream end and an open upstream end,
the strainer being received in the fluid supply conduit such that the outer peripheral surface of the body is radially spaced from the inner peripheral surface of the fluid supply conduit along at least a portion of the length of the strainer such that a flow area is defined between the outer peripheral surface of the strainer body and the inner peripheral surface of the fluid supply conduit, wherein the flow area is equal to or greater than the effective flow area of the strainer holes along the at least a portion of the length of the strainer.

2. The system of claim 1 wherein the fluid supply conduit has a first portion transitioning to a second portion, wherein the inner peripheral surface of the first portion is at a first diameter and the inner peripheral surface of the second portion is at a second diameter, wherein the second diameter is greater than the first diameter.

3. The system of claim 2 wherein the second diameter is at least about 2 millimeters larger than the first diameter.

4. The system of claim 2 wherein the second diameter is from about 2 millimeters to about 6 millimeters larger than the first diameter.

5. The system of claim 2 wherein the second diameter is at least about 40 percent greater than the first diameter.

6. The system of claim 2 wherein the strainer body is sized to be received within the first portion of the fluid supply conduit, wherein the strainer is partially located within the first portion of the fluid supply conduit and partially within the second portion of the fluid supply conduit.

7. The system of claim 6 wherein a greater portion of the strainer is located within the second portion of the fluid supply conduit than the first portion of the fluid supply conduit.

8. The system of claim 7 wherein a substantially greater portion of the strainer is located within the second portion of the fluid supply conduit than the first portion of the fluid supply conduit.

9. The system of claim 1 wherein the inner peripheral surface of the fluid supply conduit is tapered.

10. The system of claim 9 wherein the radial spacing between the outer peripheral surface of the body and the inner peripheral surface of the fluid supply conduit is substantially constant along at least a portion of the length of the strainer.

11. The system of claim 9 wherein the radial spacing between the outer peripheral surface of the body and the inner peripheral surface of the fluid supply conduit is greater in an upstream region proximate to the upstream end of the strainer than in a downstream region proximate the downstream end of the strainer.

12. The system of claim 1 wherein the fluid supply conduit is a part of a fuel supply line for a turbine engine.

13. A fluid flow straining system for a turbine engine comprising:
a fluid supply conduit connected in fluid communication to supply a fluid to a turbine engine component, the fluid supply conduit having an inner peripheral surface defining a flow supply passage, the fluid supply conduit having a first portion in which the inner peripheral surface is at a first diameter, the first portion transitioning to a second portion in which the diameter of the inner peripheral surface greater than the first diameter along at least a portion of length of the flow supply passage; and
a strainer having a hollow generally frusto-conical body with an outer peripheral surface, a plurality of holes being provided in the body, the strainer having an open upstream end and a closed downstream end, the strainer body being sized to be received within the first portion of the fluid supply conduit,
wherein the strainer is received within the fluid supply conduit such the strainer body is partially located within the first portion of the flow passage and partially within the second portion of the fluid supply conduit, the outer peripheral surface of the body being radially spaced from the inner peripheral surface of the fluid supply conduit in the second portion of the fluid supply conduit.

14. The system of claim 13 wherein the transition between the first diameter and the second diameter is a step.

15. The system of claim 13 wherein the second diameter is at least about 2 millimeters larger than the first diameter.

16. The system of claim 13 wherein the second diameter is at least about 40 percent greater than the first diameter.

17. The system of claim 13 wherein the plurality of holes in the strainer have an associated effective flow area, wherein a flow area is defined between the outer peripheral surface of the strainer body and the inner peripheral surface of the fluid supply conduit, wherein the flow area is equal to or greater than the effective flow area of the strainer holes in the second portion along the length of the strainer received in the second portion.

18. A fluid flow straining system for a turbine engine comprising:
a fluid supply conduit connected in fluid communication to supply a fluid to a turbine engine component, the fluid supply conduit having an inner peripheral surface defining a flow supply passage, at least a portion of the inner peripheral surface being tapered; and
a strainer having a hollow generally frusto-conical body with an outer peripheral surface, a plurality of holes being provided in the body, the strainer having an open upstream end and a closed downstream end, the strainer body being sized to be received within the first portion of the fluid supply conduit,
wherein the strainer is received within the fluid supply conduit such the strainer body is partially located within the first portion of the flow passage and partially within the second portion of the fluid supply conduit, the outer peripheral surface of the body being radially spaced from the inner peripheral surface of the fluid supply conduit in the second portion of the fluid supply conduit.

19. The system of claim 18 wherein the radial spacing between the outer peripheral surface of the body and tapered the inner peripheral surface of the fluid supply conduit is substantially constant along the at least a portion of the length of the strainer.

20. The system of claim 18 wherein the plurality of holes in the strainer have an associated effective flow area, wherein a flow area is defined between the outer peripheral surface of the strainer body and the inner peripheral surface of the fluid supply conduit, wherein the flow area is equal to or greater than the effective flow area of the strainer holes in the second portion along the length of the strainer received in the second portion.
